(19) United States
(12) Patent Application Publication
(10) Pub. No.: US 2012/0102241 A1
(43) Pub. Date: Apr. 26, 2012

(54) CONNECTING APPARATUS AND METHOD FOR TRANSMITTING PACKETS

(75) Inventor: Yoshiteru TAMURA, Nagoya-shi (JP)

(73) Assignee: Buffalo Inc., Aichi (JP)

(21) Appl. No.: 13/235,418

(22) Filed: Sep. 18, 2011

(30) Foreign Application Priority Data
Oct. 21, 2010 (JP) 2010-236560

(51) Int. Cl. G06F 3/00

(52) U.S. Cl. 710/30; 710/33

(57) ABSTRACT

A connecting apparatus has a connecting section to which peripheral devices are connectable and which perform communication according to a plurality of data transfer modes based on predetermined standards, a transforming section for transforming data which conforms to the predetermined standards into packets compatible with communication in a network in order to enable the connected peripheral devices to be utilized via the network, a selecting section for selecting settings at the time of transmitting the packets to the network according to the data transfer modes, and a communication section for transmitting/receiving the packets to/from the network.

### CROSS-REFERENCE TO RELATED APPLICATION

This application claims the benefit of Japanese Patent Application No. 2010-236560, filed Oct. 21, 2010, the entire disclosure of which is hereby incorporated by reference.

### BACKGROUND OF THE INVENTION

1. Field of the Invention

The present invention relates to a connecting apparatus to which peripheral devices are connectable and a method for transmitting packets.

2. Description of the Related Art

In recent years, attention has been paid to USB device servers in which users can share USB (Universal Serial Bus) devices via a network. The USB device servers use a so-called “USB Over IP (Internet Protocol)” technique to convert data based on USB standards into IP packets, so as to enable communication between USB devices and computers connected to networks.

However, in conventional USB device servers, transfer modes in USB devices are not sufficiently taken into consideration. Such a problem is not limited to the USB device servers, and is shared by general connecting apparatuses that can utilize peripheral devices via networks (for example, see Japanese Patent Application Laid-Open No. 2010-009147).

### SUMMARY OF THE INVENTION

It is an object of the present invention to provide a technique that can realize communication suitable for data transfer modes of peripheral devices.

The present invention is applied to a connecting apparatus comprising: a connecting section to which peripheral devices are connectable and which perform communication according to a plurality of data transfer modes based on predetermined standards; a transforming section for transforming data which conforms to the predetermined standards into packets compatible with communication in a network in order to enable the peripheral devices connected to the connecting section to be utilized via the network; a selecting section for selecting settings at the time of transmitting the packets to the network according to the data transfer modes; and a communication section for transmitting/receiving the packets to/from the network.

According to this constitution, since the settings at the time of transmitting the packets to the network are selected according to the transfer modes of the peripheral devices, the communication suitable for the transfer modes of the peripheral devices can be realized.

The selecting section may select a communication protocol in a transport layer according to the data transfer modes.

The selecting section may select priority of the packets according to the data transfer modes, and the communication section may transmit the packets based on the priority.

The communication section can communicate wirelessly using a radio wave. In this case, the selecting section may select settings to be used in the wireless communication according to the data transfer modes.

The selecting section may select a transmission rate in the wireless communication according to the data transfer modes.

The selecting section may select a size of data to be aggergated by frame aggregation in the wireless communication according to the data transfer modes.

The selecting section may select a number of retries in a retransmitting process in the wireless communication according to the data transfer modes.

The predetermined standards may be USB standards, and the peripheral devices may be USB devices based on the USB standards. In this case, the data transfer modes may be transfer modes based on the USB standards.

The present invention is applied to a method for transmitting packets comprising the steps of transforming data which conforms to the predetermined standards into packets compatible with communication in a network in order to enable peripheral devices to be utilized via the network, when peripheral devices communicating according to a plurality of data transfer modes based on predetermined standards are connected,; selecting settings at the time of transmitting the packets to the network according to the data transfer modes; and transmitting/receiving the packets to/from the network.

According to this method, since settings at the time of transmitting the packets to the network are selected according to the data transfer modes of the peripheral devices, suitable communication according to the data transfer modes of the peripheral devices can be realized.

The present invention can be realized in various modes. For example, the present invention can be realized as a method and an apparatus for connecting peripheral devices, a connecting system, an integrated circuit for realizing the method and the apparatus, a computer program, and a recording medium or the like in which the computer program is recorded.

### BRIEF DESCRIPTION OF THE DRAWINGS

FIG. 1 is an explanatory diagram illustrating a USB connecting apparatus and its periphery according to a first embodiment of the present invention;

FIG. 2 is an explanatory diagram illustrating an internal constitution of the USB connecting apparatus according to the first embodiment;

FIG. 3 is a flowchart illustrating a process of the USB connecting apparatus according to the first embodiment in a case where a USB device is connected to a USB downstream port;

FIG. 4 is an explanatory diagram illustrating a table that stores various communication settings corresponding to transfer modes of USB devices according to the first embodiment; and

FIG. 5 is an explanatory diagram illustrating a table that stores various communication settings corresponding to the transfer modes of the USB devices according to a second embodiment of the present invention.

### DESCRIPTION OF PREFERRED EMBODIMENTS

Embodiments of the present invention will be described below.

### First Embodiment

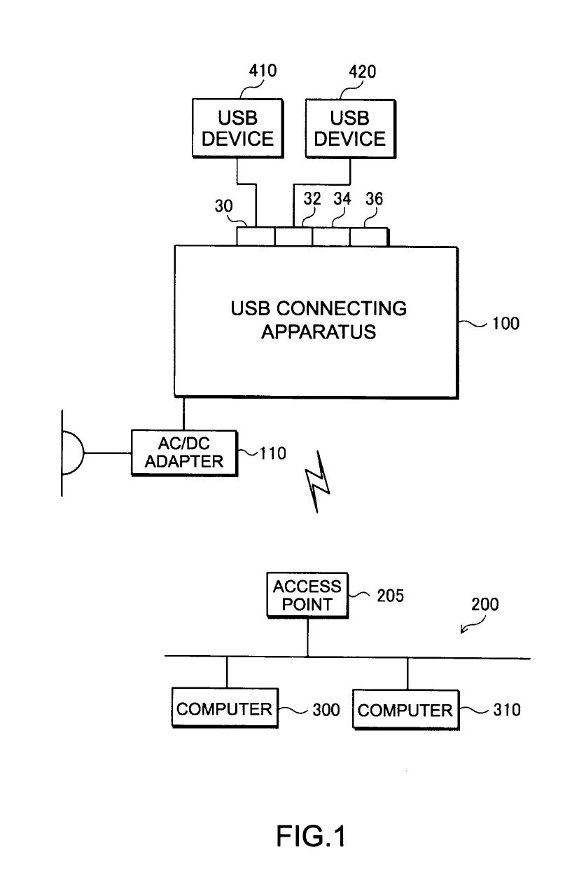

FIG. 1 is an explanatory diagram illustrating a USB connecting apparatus 100 and its periphery according to a first embodiment of the present invention. The USB connecting apparatus 100 is an apparatus that a plurality of USB devices is connectable, and has a function as a so-called “USE device server”. The USB connecting apparatus 100 can communicate with an access point 205 using a radio wave, and is connected to LAN (Local ARea Network) 200.

The USB connecting apparatus 100 enables a computer connected to a network to communicate with a USB device connected to a USB downstream port of the USB connecting apparatus 100 via the network. In an example shown in FIG. 1, computers 300 and 310 communicate with USB devices 410 and 420 that are connected to the USB downstream ports 30 and 32 of the USB connecting apparatus 100, via the LAN 200.

The USB connecting apparatus 100 communicates with the computers 300 and 310 using IP (Internet Protocol), and communicates with the USB devices 410 and 420 based on the USB 2.0 standard. That is to say, the USB connecting apparatus 100 uses a so-called “USB Over IP” technique so as to function as “the USB device server”. A power is supplied to the USB connecting apparatus 100 via an AC/DC adapter 110.

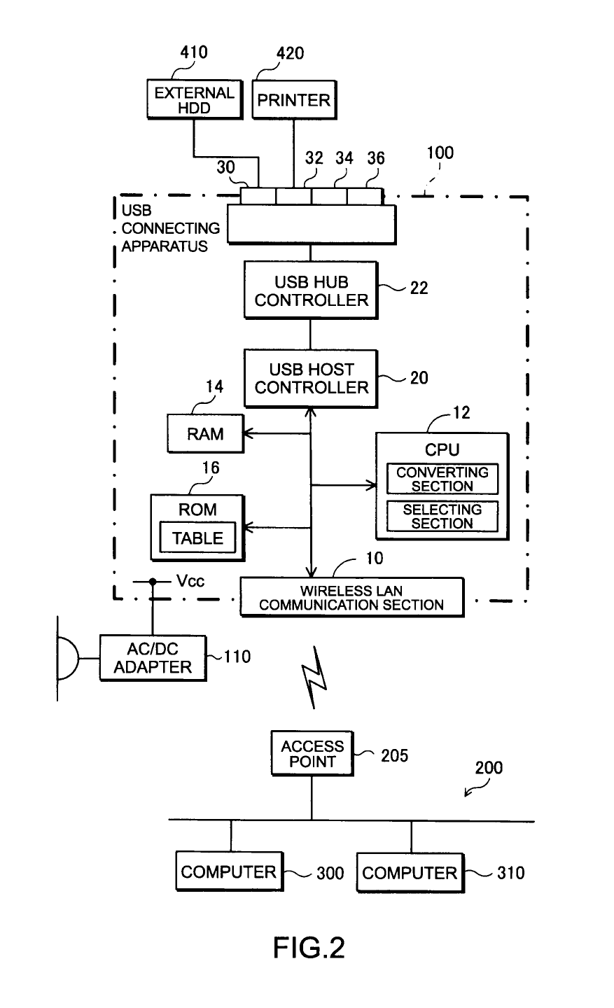

FIG. 2 is an explanatory diagram illustrating an internal constitution of the USB connecting apparatus 100 according to the first embodiment. The USB connecting apparatus 100 has a wireless LAN communication section 10, a CPU (Central Processing Unit) 12, a RAM (Random Access Memory) 14, a ROM (Read Only Memory) 16, a USB host controller 20, a USB hub controller 22, and four USB downstream ports 30, 32, 34 and 36. USB devices such as an USB external hard disc drive (HDD) 410 and an USB printer 420 are connected to the USB downstream ports 30, 32, 34 and 36.

The USB hub controller 22 detects whether USB devices are connected or not, detects a communication speed, converts the communication speed, distributes a signal, and manages supply of a power to the USB devices. The USB host controller 20 controls the various USB devices connected to the USB downstream ports 30, 32, 34 and 36.

The CPU 12 spreads out programs stored in the ROM 16 into the RAM 14 and executes the programs so as to variously control the USB connecting apparatus 100. Concretely, for example, the CPU 12 converts (encapsulates) data of a format based on the USB standards received from the USB devices into IP packets, and converts IP packets received from the wireless LAN communication section 10 into data of a format based on the USB standards receivable by the USB devices. As described later, the CPU 12 obtains transfer modes of the USB devices from the USB host controller 20, and selects settings to be used for transmission of IP packets to the LAN 200 according to the transfer modes of the USB devices. That is to say, the CPU 12 functions as a transforming section and a selecting section of the present invention.

The wireless LAN communication section 10 can carry out wireless communication based on IEEE (The Institute of Electrical and Electronics Engineers) 802.11 standards, and can communicate with the computers 300 and 310 connected to the LAN 200 via the access point 205. Concretely, the wireless LAN communication section 10 encapsulates IP packets to generate MAC (Media Access Control) frames (hereinafter, also referred to as “wireless frames”), and transmits/receives the wireless frames to/from the access point 205 using a radio wave of 2.4 GHz band or 5 GHz band.

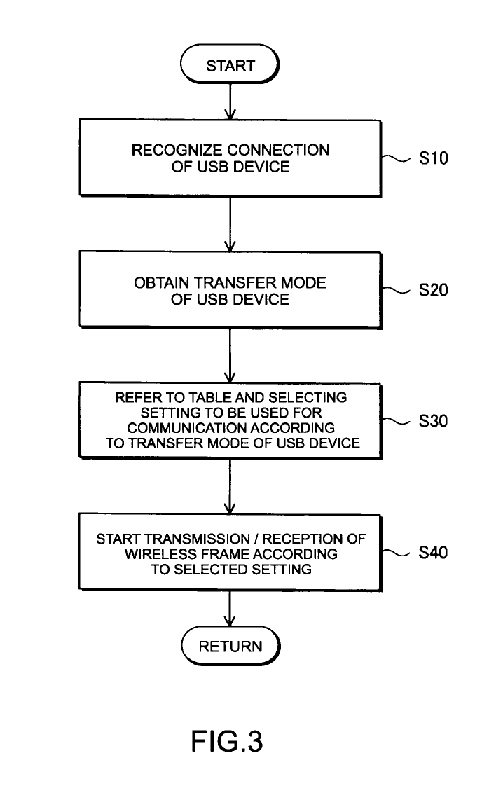

FIG. 3 is a flowchart illustrating a process of the USB connecting apparatus 100 in a case where a USB device is connected to a USB downstream port. The CPU 12 recognizes that the USB device is connected to the USB downstream port at step S10. The CPU 12 acquires a data transfer mode of the USB device from the USB host controller 20 at step S20. The CPU 12 refers to the table at step S30, and selects a setting to be used for transmitting the IP packets to the LAN 200 according to the data transfer mode of the USB device. Contents of the table will be described later. The wireless LAN communication section 10 starts transmitting/receiving the wireless frames in which the IP packets are stored, according to the selected setting at step S40.

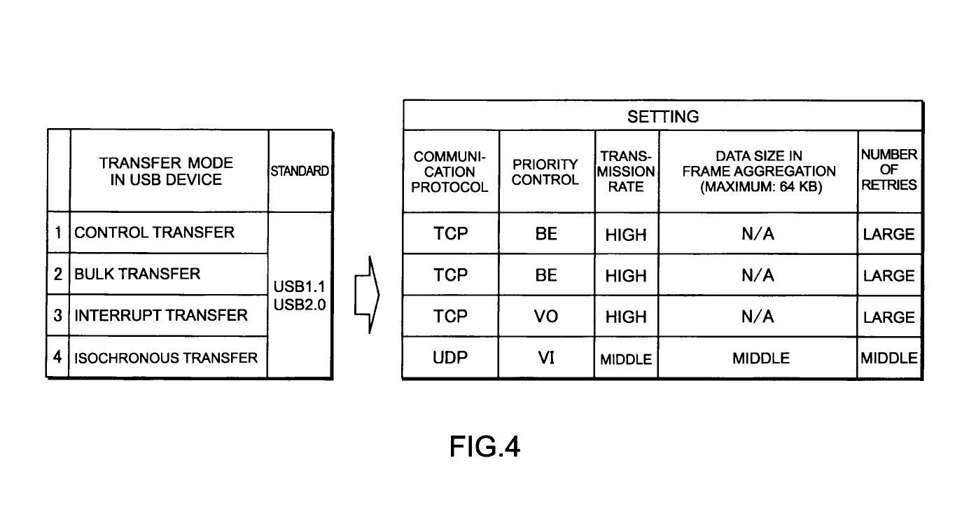

FIG. 4 is an explanatory diagram illustrating a table that stores various communication settings corresponding to the transfer modes of the USB devices. The table shown in FIG. 4 is stored in the ROM 16 (FIG. 2). The CPU 12 refers to the table stored in the ROM 16 so as to select a setting to be used for transmission of the IP packets according to the data transfer mode of the USB device.

Concretely, the CPU 12 selects a communication protocol in a transport layer, a priority in priority control, and a setting to be used for communication using wireless LAN, according to the transfer mode of the USB device. The setting to be used for the communication via wireless LAN includes, for example, a transmission rate in multi-rate control, a data size in frame aggregation, and a number of retries in a retransmitting process of a wireless frame.

The data transfer modes of the USB devices, the communication protocol in the transport layer, the priority control, the multi-rate control, the frame aggregation, and the retransmitting process will be described below.

The data transfer modes of the USB devices include four data transfer modes composed of the control transfer, bulk transfer, interrupt transfer and isochronous transfer.

The control transfer mode is the data transfer mode for recognizing, setting and controlling the USB devices. Therefore, in this control transfer mode certainty of the data transfer is required but immediacy is not required.

The bulk transfer mode is the transfer mode for transferring a large amount of data non-periodically. The bulk transfer mode is used for communication that requires the certainty of the data transfer but does not require the immediacy. The bulk transfer mode is applied to a storage device, a scanner, or the like to be USB-connected, for example.

The interrupt transfer mode is the transfer mode for transferring data at a constant interval. The interrupt transfer is used for the communication that requires the certainty and immediacy of the data transfer. The interrupt transfer mode is applied to a keyboard, a mouse, or the like to be USB-connected.

The isochronous transfer mode is the transfer mode for transferring data continuously. Since the isochronous transfer is the transfer mode in which data is not retransferred, it is used for the communication that requires the immediacy, rather than the certainty, of the data transfer. The isochronous transfer mode is applied, for example, for inputting/outputting data to/from video or audio device.

As to the transfer modes of the USB devices, each transfer mode that is used for each USB device is normally predetermined, and information representing adoption of each transfer mode is stored in each USB device. The USB hub controller 22 and the USB host controller 20 recognize a USB device that is connected, and obtains information about the transfer mode predetermined by the USB device at the time of setting. The control transfer mode is a transfer mode to be used at the time of recognition and setting of the USB devices, and all the USB devices use the transfer modes based on this control transfer mode at the very least at the time of recognition and setting of these USB devices.

The CPU 12 selects TCP (Transmission Control Protocol) or UDP (User Datagram Protocol) as the communication protocol in the transport layer.

TCP is a protocol for establishing a session and making one-to-one communication, and has an error correcting function such as retransfer or the like of a missing packet. Therefore, TCP is the protocol with great certainty, and is used for the transmission that requires the certainty rather than the communication speed.

UDP is a connectionless protocol with which delivery is not acknowledged. Therefore, UDP is the high-speed protocol and is used for the communication that requires the communication speed rather than the certainty.

In the first embodiment, the CPU 12 selects a communication protocol to be used in the transport layer according to the transfer modes of the USB devices. Concretely, for the “control transfer mode”, “bulk transfer mode” and “interrupt transfer mode” that require the certainty of the data transfer, the CPU 12 selects “TCP” as the communication protocol in the transport layer. On the other hand, for the “isochronous transfer mode” that requires the communication speed rather than the certainty, the CPU 12 selects “UDP” as the communication protocol in the transport layer.

In such a manner, the certainty of the data transfer can be secured for the “control transfer mode”, “bulk transfer mode” and “interrupt transfer mode”. The high communication speed can be secured for the “isochronous transfer mode”.

The priority control is a control for setting priorities to packets (or wireless frames) waiting to be transmitted, and for transmitting packets with higher priority sequentially on a priority basis. The priorities based on IEEE 802.11e standard have four classes including voice (VO: top priority), video (VI: priority) best effort (BE: standard) and background (BK: low) in decreasing order. The priority control is one kind of QoS (Quality of Service).

In the first embodiment, the CPU 12 selects the priority in the priority control operation according to the transfer modes of the USB devices. Concretely, the CPU 12 selects “voice” with top priority for the “interrupt transfer mode” that most requires the immediacy, and selects “video” with second priority for the “isochronous transfer mode”. The CPU 12 selects “best effort” for the “control transfer mode” and “bulk transfer mode”.

In such a manner, since the packets (wireless frames) relating to the “interrupt transfer mode” and “isochronous transfer mode” are transmitted preferentially, the immediacy of the data transfer required by “interrupt transfer mode” and “isochronous transfer mode” can be secured.

The “multi-rate control” is a control for selecting a transmission rate at the time of transmitting wireless frames from a plurality of transmission rates. When a high transmission rate is selected, the communication speed is high but a transmission distance is short. On the other hand, when a low transmission rate is selected, the communication speed is low but the transmission distance is long.

In the first embodiment, the CPU 12 selects the transmission rate in the multi-rate control according to the transfer modes of the USB devices. Concretely, the CPU 12 selects “high” that means the high transmission rate for the “control transfer mode”, “bulk transfer mode” and “interrupt transfer mode”. On the other hand, the CPU 12 selects “middle” that means an intermediate transmission rate for the “isochronous transfer mode”. Concrete values are stored as the transmission rates in the table actually.

The “frame aggregation” means that a pack of many data is aggregated and transmitted with overheads (additional regions) such as a MAC header and a PLOP (Physical Layer Convergence Protocol) header being shared. The use of this frame aggregation enables the overheads at the time of transmitting data to be compressed, so that transfer efficiency of the data can be improved.

Examples of a method of the frame aggregation that can be used include a method for aggregating a plurality of MSDUs (MAC Service Data Units) and adding one common MAC header to this so as to generate a long MAC frame, and a method for aggregating a plurality of PSDUs (PLCP Service Data Units) that are a transmission data unit in a physical layer and adding one common PLCP preamble to this so as to generate a long wireless frame.

In the first embodiment, the CPU 12 determines whether the frame aggregation is carried out according to the transfer modes of the USB devices, and selects a size of data aggregated by the frame aggregation. Concretely, the CPU 12 determines that the frame aggregation is carried out for the “isochronous transfer mode”, and selects “middle” that means a middle size as the size of the data to be aggregated by the frame aggregation. In such a manner, when the frame aggregation is carried out, the efficient data transfer can be realized in the “isochronous transfer mode”.

In the “control transfer mode”, “bulk transfer mode” and “interrupt transfer mode”, since data is not continuously transmitted from a host side or a device side, the frame aggregation is not carried out. Concrete values are stored as the sizes of data aggregated by the frame aggregation in the table actually.

The “retransmitting process” is a process for retransmitting the same wireless frame when the wireless frame does not reach a transmission destination. A number of retries in the retransmitting process means a number of retransmitting times of a wireless frame.

In the first embodiment, the CPU 12 selects the number of retires in the retransmitting process according to the transfer modes of the USB devices. Concretely, the CPU 12 selects “large” that means the large number of retries for the “control transfer mode”, “bulk transfer mode” and “interrupt transfer mode” requiring the certainty of the data transfer. On the other hand, the CPU 12 selects “middle” that means a middle number of retries for the “isochronous transfer mode” that requires the communication speed rather than the certainty.

In such a manner, the certainty of the data transfer can be secured for the “control transfer mode”, “bulk transfer mode” and “interrupt transfer mode”. Concrete values are stored as the number of retries in the table actually.

According to the first embodiment, since the setting at the time of transmitting a packet is selected according to the transfer modes of the USB devices, optimum communication can be made according to requirements such as the certainty and the immediacy of the data transfer.

### Second Embodiment

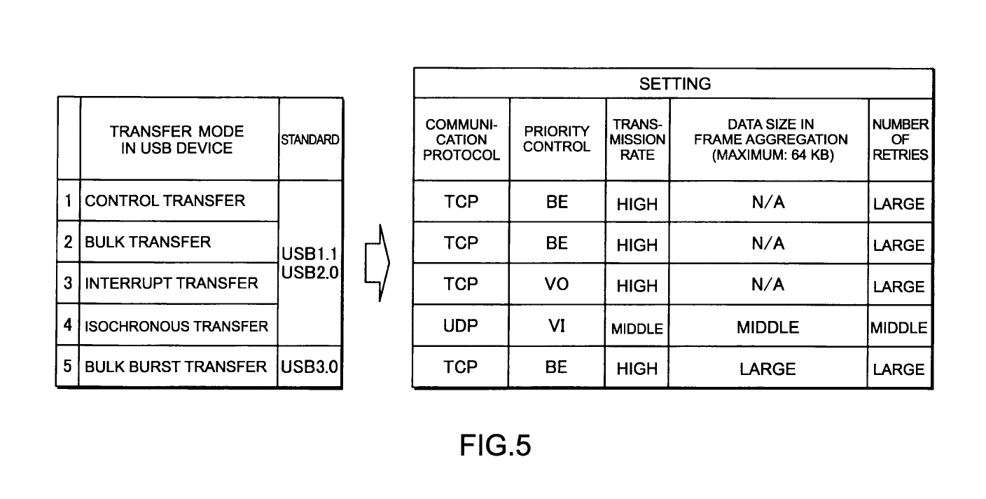

FIG. 5 is an explanatory diagram illustrating the table that stores various communication settings corresponding to the transfer modes of the USB devices according to a second embodiment of the present invention. The only difference from the first embodiment shown in FIG. 4 is that “bulk burst transfer mode” is added to the transfer modes of the USB devices, and the other parts of the constitution are the same as those in the first embodiment.

The bulk burst transfer mode is the transfer mode added by USB 3.0 standard. The bulk burst transfer mode is used for a case where large volumes of data are transferred at a high speed.

The CPU 12 according to the second embodiment selects “TCP” as the communication protocol in the transport layer for “the bulk burst transfer mode”, and selects “best effort” as the priority in the priority control. The CPU 12 selects “high” that means a high transmission rate as the transmission rate in the multi-rate control for “the bulk burst transfer mode”. The CPU 12 selects “large” as the size of the data compiled by the frame aggregation for “the bulk burst transfer mode”, and selects “large” that means a large number of retries as the number of retries in the retransmitting process.

As a result, the certainty of the data transfer can be secured for “the bulk burst transfer mode”, and a high-speed data transfer can be realized.

The present invention is not limited to the above embodiments, and can be made in various modes within a range that does not deviate from the gist. For example, the following modification can be made.

The contents of the tables shown in FIGS. 3 and 4 according to the first and second embodiments may be rewritable. As a result, the various settings can be suitably changed according to the transfer modes of the USB devices. The tables may be rewritten by the computer 300 connected to the LAN 200, for example.

In the above embodiments, the USB connecting apparatus 100 is provided with the wireless LAN communication section 10, but may be provided with a wired LAN interface instead. In this case, QoS such as the priority control may be carried out in the wired LAN interface. Further, the USB connecting apparatus 100 may be provided with the wired LAN interface in addition to the wireless LAN communication section 10.

The above embodiments described the USB 2.0 standard and the USB 3.0 standard as communication standards of the USB devices, but the present invention can be applied also to other USB standards such as the USB 1.0 standard and the USB 1.1 standard. Further, the present invention can be applied also to other serial communication standards such as IEEE 1394 and eSATA (external Serial ATA). The communication between the USB connecting apparatus 100 and the computers 300 and 310 may be realized by the communication protocol other than TCP/IP. Examples of the communication protocol other than TCP/IP include AppleTalk (registered trademark), IPX (Netware), NetBEUI, and DECnet.

In the above embodiments, the USB connecting apparatus 100 has the four USB downstream ports, but the USB connecting apparatus 100 may be provided with not more than three or not less than five USB downstream ports.

In the above embodiments, some of the functions realized by software may be realized by hardware, or some of the functions realized by hardware may be realized by software.

What is claimed is:

1. A connecting apparatus comprising:
a connecting section to which peripheral devices are connectable and which communicate according to a plurality of data transfer modes based on predetermined standards;
a transforming section for transforming data which conforms to the predetermined standards into packets compatible with communication in a network in order to enable the peripheral devices connected to the connecting section to be utilized via the network;
a selecting section for selecting settings at the time of transmitting the packets to the network according to the data transfer modes; and
a communication section for transmitting/receiving the packets to/from the network.

2. The connecting apparatus according to claim 1, wherein the selecting section selects a communication protocol in a transport layer according to the data transfer modes.

3. The connecting apparatus according to claim 1, wherein
the selecting section selects a priority of the packets according to the data transfer modes, and
the communication section transmits the packets based on the priority.

4. The connecting apparatus according to claim 1, wherein
the communication section can communicate wirelessly using a radio wave, and
the selecting section selects settings to be used in the wireless communication according to the data transfer modes.

5. The connecting apparatus according to claim 4, wherein
the selecting section selects a transmission rate in the wireless communication according to the data transfer modes.

6. The connecting apparatus according to claim 4, wherein
the selecting section selects a size of data to be aggregated by frame aggregation in the wireless communication according to the data transfer modes.

7. The connecting apparatus according to claim 4, wherein
the selecting section selects a number of retries in a retransmitting process in the wireless communication according to the data transfer modes.

8. The connecting apparatus according to claim 1, wherein
the predetermined standards are USB standards, and
the peripheral devices are USB devices based on the USB standards, and
the data transfer modes are transfer modes based on the USB standards.

9. A method for transmitting packets, comprising the steps of:
transforming data which conforms to the predetermined standards into packets compatible with communication in a network in order to enable peripheral devices to be utilized via the network, when peripheral devices communicating according to a plurality of data transfer modes based on predetermined standards are connected;
selecting settings at the time of transmitting the packets to the network according to the data transfer modes; and
transmitting/receiving the packets to/from the network.
